(19) United States
(12) Patent Application Publication
(10) Pub. No.: US 2004/0213923 A1
(43) Pub. Date: Oct. 28, 2004

(54) Process for preparing positive-negative blended optical retardation film, positive-negative blended optical retardation film, and liquid crystal display element and liquid crystal display device using the same

(75) Inventors: Long-Hai Wu, Bade City (TW); Chain-Shu Hsu, Hsinchu (TW); Ching-Hua Ting, Yonghe City (TW)

Correspondence Address: BACON & THOMAS, PLLC, 625 SLATERS LANE, FOURTH FLOOR, ALEXANDRIA, VA, 22314

(73) Assignee: National Chiao Tung University, Taiwan, R.O.C.

(21) Appl. No.: 10/259,474

(22) Filed: Sep. 30, 2002

(30) Foreign Application Priority Data
Feb. 8, 2002 (TW) 91117473

(51) Int. Cl. B05D 5/06; B05D 3/06; C09K 19/00

(52) U.S. Cl. 428/1.1; 427/558; 427/162

(57) ABSTRACT

The invention provides a process for preparing a positive-negative-blended optical retardation film comprising coating a solution consisting of discotic and rod-like liquid crystal onto an alignment layer after unidirectionally rubbing treatment on a substrate, subsequently heating the coating to obtain a film consisting of discotic and rod-like liquid crystal with uniform arrangement, and then curing it through exposing under a UV-irradiation to obtain a positive-negative-blended optical retardation film with excellent viewing angle; and a positive-negative-blended optical retardation film. Further, the invention also provides a liquid crystal element and a liquid crystal device having said positive-negative-blended optical retardation film.

### FILED OF THE INVENTION

The invention relates to a process for the preparation an optical retardation film, particularly to a process for the preparation optical retardation film having a uniform structure of positive-negative blended layer. The invention also provides an optical retardation film having a uniform structure of positive-negative blended layer and a liquid crystal display using thereof.

### BACKGROUND OF THE INVENTION

Generally, a liquid crystal display (LCD) comprises a liquid crystal cell, a polarizing sheet and an optical compensatory sheet (phase retarder) provided between the liquid crystal cell and the polarizing sheet. The LCD utilizes the polarization of optical rotation and property of birefrigence of a liquid crystal molecule to achieve the efficacy of showing bright ness and darkness. Thus, the display quality of LCD is different to each viewer in a various location and depends on the viewing angle of a viewer. Further, the scale of LCD has been enlarged more and more in recent years and to increase the width of viewing angle is thus more and more important than ever.

Recently, there are several new processes with modified technology such as (1) optical compensation film; (2) multi-domain vertical alignment (MVA); (3) in plane switching (IPS) and so on which have been reported to modify the viewing angle of LCD. In these technologies for widen the viewing angle of LCD, the process (2) and (3) are not popularized since they involve a complicate process of manufacturing a liquid crystal cell and particularly under normal occasions, they still need to add another optical compensation film to increase the viewing angle. However, the process (1) of optical compensation film is easily manufactured and operated by adhesion merely and thereby it is broadly used on the purpose of modifying the viewing angle of conventional LCD. Especially, the manufacture of LCD with widen viewing angle is also made by the process of using optical compensation film at nowadays.

In general, the optical compensation film is classified into two kinds of positive type and negative type. Conventionally, the positive type optical compensation film is used for reducing the operation voltage of liquid crystal panel and is obtained by the stretch of a rod-like molecule or a polymer such as polystyrene (PS), polyvinyl chloride (PVC), polycarbonate (PC) and so on. On the other hand, the negative type optical compensation film is used for modifying the viewing angle of LCD and is made from polyimide (PI) or a discotic liquid crystal. Generally, these positive and negative type optical compensation films are adhered onto one side of liquid crystal panel.

Further, according to the viewpoint of the distribution of optical axes, the conventional optical compensation film also can be divided into several kinds such as (a) C-plate; (b) optical compensation film having an optical rotating structure; (c) optical compensation film having an bi-optical-axes; and (d) discotic optical compensation film

Typically, the C-plate type optical compensation film has an optical property of nₓ=n_{y}>n_{z} as reported by F. Li, F. W. Harris, and S. Z. D. Cheng, (“polymer”, 1996, vol. 37, pp. 5321). The C-plate type optical compensation film does not affect the display quality of LCD at vertical direction since it has an optical property of nₓ=n_{y}. Further, the C-plate type optical compensation film has the optical property of negative birefrigence (Δn=n_{z}−nₓ<0), which is opposite to the positive birefrigence of rod-like liquid crystal molecule. Thus, it is suitable to be used for the compensation of optical leakage produced by the liquid crystal molecule located vertically to the substrate of liquid crystal elements so as to increase the viewing angle between TN and vertical display module. The conventional C-plate type optical compensation film is made from polyimide (PI) by carrying out a process of coating PI polymer and then curing it with high temperature. However, the PI film has lower efficiency of optical compensation since that it has higher absorption at blue band and its distribution trend of birefrigence with respect to wave does not consistent with the liquid crystal used in LCD.

For improving the problems arised from optical rotation, birefrigence and so on, an optical compensation film with rotating structure made from a liquid crystal polymer was proposed by S. Nishiuria, T. Toyooka, and T. Matsumoto, H. Itoh, T. Satoh, (“SID 95 Digest”, 1995, pp. 567). The process for producing such optical compensation film with rotating structure is coating a liquid crystal polymer blending with optical acitvator onto a orientation film after treatment of orientation by rubbing, treating it under high temperature to form a spiral structure and then forming a crosslinked net structure by subjecting it through exposure. The resulted optical compensation film can compensate the optical rotation and birefrigence of STN and has the merit of its retardation being changeable according to the temperature. However, the process for the preparation of such optical compensation film with rotating structure is too complicate and thereby it being hardly to practice.

Besides, for the compensation of the asymmetry of liquid crystal in LCD, an optical compensation film having the property of birefrigence was developed. For example, the optical compensation film with birefrigence disclosed by T. Yamakaki, H. Kawakami, and H. Hari (“Color TFT Liquid Crystal Displays”, 1996, semicoductor equipment and materials international, pp. 87). Such optical compensation film is generally obtained by coating a PI film and rubbing its surface or subjecting it to bi-axial stretch so as to possess the property of birefrigence. The optical compensation film has negative birefrigence on the X-Z plane and the birefrigence on X-Y plane is the same as X-Z. Though the optical compensation film can compensate the asymmetry of liquid crystal in LCD, however the retardation produced by rubbing is too small. Further, the quality of resulted film might be reduced by formation of scrap formed during rubbing stage and thus such optical compensation film is hardly to use. Moreover, the process of using bi-axial stretch is too difficult to control the quality of obtained film and thereby it seldom be used for manufacturing optical compensation film.

Nowadays, the most common used optical compensation film is the so-called Fuji Film produced by Fuji Film Company at 1996. The Fuji Film is an optical compensation film having widen viewing angle and hybrid structure obtained by using photo-polymerizable discotic liquid crystal molecule (H. Mori, Y. Nishiuria, T. Nakamura, and Y Shinagaea, “AM-LCD'96/IDW'96, proceedings of the third international display workshops”, kobe, 1996, vol. 1, pp. 89). The discotic liquid crystal has birefrigence and thereby it is suitable for manufacturing various optical compensation films easily obtained by utilizing different orientation process. Recently, it has been proposed to use discotic liquid crystal as an optical compensation film. For examples, an optical compensation film disclosed by M. LU, and K. H. Yang (“SID 00 DIGEST”, 2000, pp. 338), which comprises discotic liquid crystal having vertical twisted arrangement and can compensate a liquid crystal panel with single domain TN (1DTN) or two-domain TN (2DTN). The LCD comprising an optical compensation film consisting of a discotic liquid crystal may have the merits of wide viewing angle, low operation voltage, rapid response, without difference of color and optical leakage at bondary of 2DTN. However, the LCD comprising an optical compensation film consisting of a discotic liquid crystal still has several disadvantages such as no desired retardation value, complicate production, requirement of multiple steps of adhesion, high cost of manufacture and so on.

### SUBJECTS TO BE SOLVED BY THE INVENTION

The subjects to be solved by the invention are to find the solutions for aforesaid problems and to simplify the manufacturing process of preparing optical compensation film without disadvantages mentioned above. Further, other subjects are to provide an optical compensation film having positive and negative compensation simultaneously and to provide LCD element and/or LCD comprising the same.

### SOLUTIONS FOR THE SUBJECTS

The invention provides a process of preparing optical compensation film having simplified steps of adhesion and no disadvantages of prior arts. It is possible to manufacture an optical compensation film having positive and negative compensation by using the process of preparing optical compensation film according to the invention. Further, according to the process of preparing optical compensation film of the invention, it also provides an optical compensation film and LCD element and/or LCD comprising the same.

### SUMMARY OF THE INVENTION

One of the objects of the invention is to provide a process for preparing optical retardation film, which is characterized in that the process comprises preparing an alignment layer consisting of a crosslinkable structure of polymer material onto the clean and transparent substrate consisting of glass or plastics, coating a liquid crystal formulation of a mixture of blending a discotic liquid crystal molecule with a rod-like liquid crystal molecule onto the alignment layer, forming a coating layer with a function of optical compensation after curing it through exposing under a light, and thereby obtaining a positive-negative blended optical retardation film.

Another object of the invention is to provide an optical retardation film comprising a positive-negative blended optical retardation film consisting of a discotic liquid crystal molecule and a rod-like liquid crystal molecule, in which the optical retardation film is a coating layer having function of optical compensation obtained by subjecting a coating of a liquid crystal formulation of a mixture of blending a discotic liquid crystal molecule with a rod-like liquid crystal molecule to the treatment of orientation, exposure, polymerization and crosslinkage.

Further, the other subjects of the invention are to provide a liquid crystal element or a liquid crystal display comprising an optical retardation film made by the process for preparing optical retardation film according to the invention.

The present invention is further described in detail with reference to the accompanying drawing and the preferred illustrative embodiments are as follows.

### BRIEF DESCRIPTION OF DRAWING

FIG. 1 shows a schematic chart using for measuring the arrangement of rod-like liquid crystal molecule presented in an optical retardation film made by the examples of the invention.

FIG. 2 is a chart showing the relationship between wave length and intensity of rod-like liquid crystal molecule, presented in an optical retardation film made by the examples of the invention, at perpendicular and parallel direction related to a polarization plate.

FIG. 3 is a sectional view schematically showing the structure of a positive-negative blended optical retardation film according to the invention.

FIG. 4 is a chart showing the relationship between angle and Re/Re₄₀ of a positive-negative blended optical retardation film of the invention measured at various angles.

FIG. 5 is a chart showing the relationship between wave length and d Δn of a positive-negative blended optical retardation film made in various conditions of heating temperature according to the invention.

FIG. 6 is a chart showing the viewing angles of a TN liquid crystal cell comprising an positive-negative blended optical retardation film of the invention.

### DETAILED DESCRIPTION OF THE INVETION

According to the first aspect, the invention provides an optical retardation film using for increasing the viewing angle of LCD, in which the optical retardation film is obtained by subjecting a formulation consisting of discotic liquid crystal material and rod-like liquid crystal material to orientation and polymerization.

In accordance with the process for preparing optical retardation film of the invention, the optical retardation film is obtained by preparing a substrate with alignment layer, coating a formulation consisting of liquid crystal with photo-polymerizable functional groups onto the substrate, annealing it under an appropriate temperature and exposing under a UV light to polymerize the liquid crystal polymer. The preparing a substrate with alignment layer according to the invention comprises steps of coating an alignment layer onto a substrate and applying orientation treatment of a rubbing orientation or an optical orientation to the coating.

According to the process for preparing optical retardation film of the invention, aforesaid alignment layer does not particularly restricted to certain material and can be any material of a polymer used in convention so long as it has crosslinkable group. For examples, the matrix material formed to be an alignment layer could be any one selected from the group consisting of polyimide (PI), polyvinyl alcohol (PVA) and a discotic monomer-containing polymer. The substrate used in the process for preparing optical retardation film of the invention, for example, it could be a glass substrate or a soft plastic substrate such as any one selected from a group consisting of polycarbonate, polyether sulfone, polymethyl methacrylate and polytriacetyl cellulose.

According to the process for preparing optical retardation film of the invention, the aforesaid discotic liquid crystal molecule is preferably to comprise a monomer having a photo-polymerizable functional group with UV light. For example, the monomer comprised in a disclostic liquid crystal molecule having a photo-sensitive functional group for photo polymerization could be any one or more selected from a group consisting of a discotic liquid crystal acrylate represented by following general formula (I), discotic liquid crystal methyl acrylate represented by following general formula (II), a discotic liquid crystal ethylene oxide represented by following general formula (IV), a discotic liquid crystal coumarin represented by following general formula (IV), a discotic liquid crystal cinnamate represented by following general formula (V), and a discotic liquid crystal cinnamic alcohol represented by following general general formula (VI).

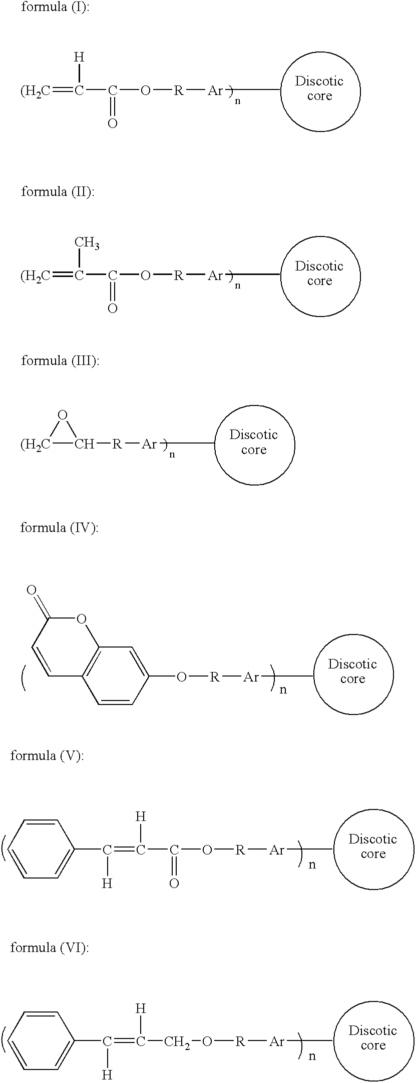

Wherein the general formula (I) to (VI) mentioned above, R represents alkyl group or alkoxyl group; Ar represents aromatic group such as phenyl or naphthyl group, and it also could be omitted; n represents the number of branch presented in a discotic monomer molecule, which depends on the central core structure of used discotic molecule and generally is an integral within the range of 1 to 50.

Further, according to the process for preparing optical retardation film of the invention, aforesaid central core structure of discotic molecule is not particularly restricted. For example, central core structure of discotic molecule used in the invention could be the one having a structure represented by following formula:

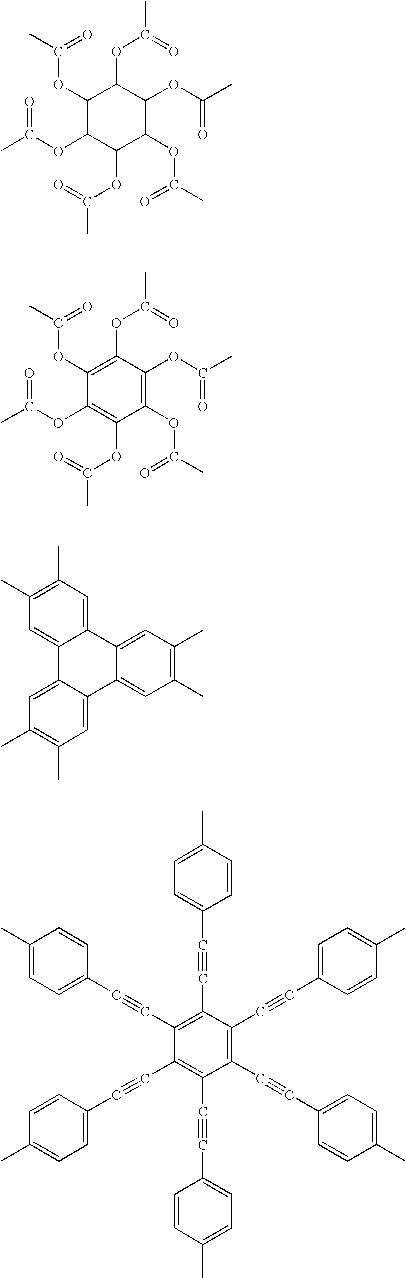

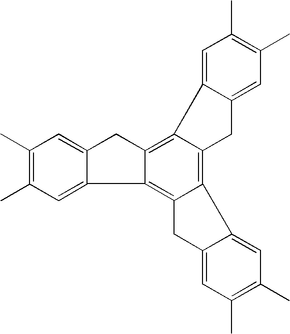

According to the process for preparing optical retardation film of the invention, the aforesaid rod-like liquid crystal molecule is preferably to comprise a monomer having a photo-polymerizable functional group with UV light. For example, the monomer comprised in a rod-like liquid crystal molecule having a photo-sensitive functional group for photo polymerization could be a rod-like liquid crystal with mono-functional group represented by following general formula (VII) or rod-like liquid crystal with bi-functional group represented by following general formula (V1H).

P—R—Ar—X formula (VII)

P—R—Ar—R—P formula (VIII)

Wherein the general formula (VII) to (VIII) mentioned above, aforesaid P of a photo-polymerizable functional group with UV light is not particularly restricted. For examples, P could be such as a functional group represented by acrylate, methyl acrylate, ethylene oxide, coumarin, cinnamate and cinnamic alcohol.

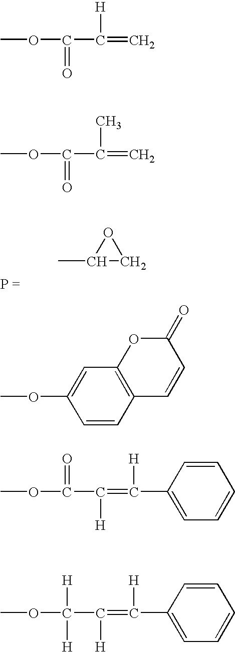

Wherein the general formula (VII) to (VIII) mentioned above, R represents alkyl group or alkoxyl group; Ar represents such as an aromatic ring or a aliphatic ring, and it also could be omitted; X represents an end group such as a cyanoic group, an alkoxyl group or an alkyl group. Further, according to the process for preparing optical retardation film of the invention, aforesaid an aromatic ring or a aliphatic ring is not particularly restricted. For examples, the aromatic or aliphatic ring could be such as a structure represented by following formula:

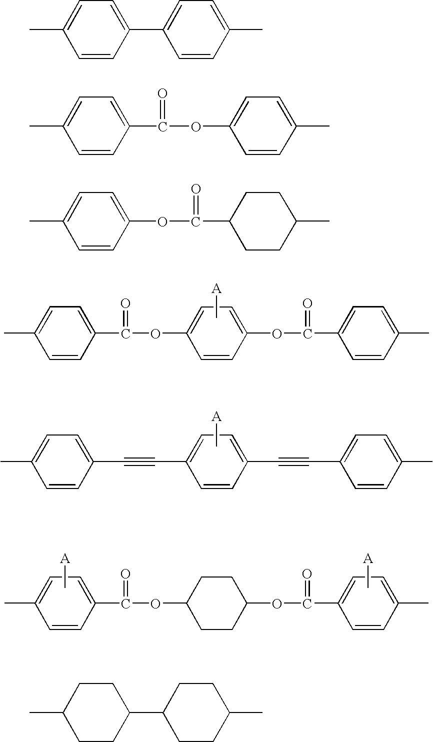

Wherein A represents a hydrogen atom, an alkyl group or a halogen atom.

Furthermore, according to the process for preparing optical retardation film of the invention, the rod-like crystal liquid molecule also could be have no functional group which is photo-polymerizable by reacting with UV light. For examples, the rod-like crystal liquid molecule could be a rod-like crystal liquid molecule represented the general formula (VII) to (VIII) but without a photo-sensitive functional group of P mentioned above.

More, according to the process for preparing optical retardation film of the invention, the aforesaid liquid crystal formulation is preferably blended with a photoinitiator in a certain ratio. The photoinitiator used in the invention is not particularly restricted. For example, under a condition of free ion type polymerization, the photoinitiator is any one or more radical photoinitiators selected from the group consisting of benzoin benzil and benzophenone. Under a condition of free ion type polymerization, the photoinitiator is any one or more anionic photoinitiators selected from the group consisting of diphenyliodonium-hexafluoroarsenate, diaryl-iodonium-hexafluoroantimonate and triarylsulfonium-hexafluoroantimonate.

Besides, according to the process for preparing optical retardation film of the invention, the annealing temperature is not particularly restricted and however depends on the formulation of a liquid crystal. For examples, the annealing temperature is preferably within a range of 15° C.˜180° C. More, during the reaction of polymerization, the annealing temperature preferably keeps at an appropriate temperature. Aforesaid appropriate temperature depends on the formulation of a liquid crystal, and however it is preferably within a range of 15° C.˜180° C.

Furthermore, the efficacy of compensation is determined by the arrangement of an optical retardation film and thereby it is quite important that makes measurement and assessment of the arrangement to a liquid crystal molecule in a retardation film. According to a prior art of a publication reported by T. Sergan, M. Sonpatki, J. Kelly and L. C. Chien (“SID Tech. Dig.”, Vol. 31, 2000, pp. 1091), it is known that the arrangement of liquid crystal molecule is a hybrid form between a lower place contacting with the bottom of alignment layer and a upper place contacting with air while coating a discotic liquid crystal formulation onto an alignment film made of a polyimide after the treatment of orientation. Therefore, in case of a discotic liquid crystal formulation blending with a rod-like liquid crystal, it is required to further determine and assess the arrangement of liquid crystal molecule. The measurement and assessment for a liquid crystal molecule in a retardation film is described in detail by the embodiments illustrated in the examples of the invention.

The invention is further described in detail by the embodiments as below.

### THE PREFERRED EMBODIMENTS OF THE INVENTION

### EXAMPLES OF SYNTHESIS

1. The Synthesis of a Discotic Liquid Crystal Molecule of 2,3,6,10,11-hexakis [4-(ω-epoxynonyloxy)-1-benzoate]triphenylenes:

The one of preferred embodiments of a discotic liquid crystal molecule used in the invention is 2,3,6,10,11-hexakis [4-(ω-epoxynonyloxy)-1-benzoate]triphenylenes. The synthesis of a discotic liquid crystal molecule of 2,3,6,10,11-hexakis [4-(ω-epoxynonyloxy)-1-benzoate]triphenylenes can be achieved by utilization the process such as represented by the scheme 1 of synthesis described as following.

Firstly, a spacer group is synthesized by a process such as (1) V. Percec, and B. Hahn, “J. Polym., Sci. Polym. Chem”, 1989, vol. 27, pp. 2367; (2) V. Percec, C. S. Hsu, and D. Tomazos, “J. Polym., Sci. Polym. Chem.”, 1988, vol. 26, pp. 2047; or (3) J. L. Lin,. and C. S. Hsu, “Polym. J”, 1993, vol. 25, pp. 15.

Subsequently, the veratrole (23 g, 166 mmol) is slowly dropwise added into a suspension of dichloromethane (500 ml) comprising FeCl₃ (81 g, 0.500 mmol) and condensed sulfuric acid (1.6 g). After stirring for 2 hours, subjecting the reacting solution to filtration, washing the obtained dark blue solid by methanol and there by a white solid is collected. Then, the resulted white solid is further purified by using a column chromatography (extracting liquid:CH₃Cl) and thereby 15 g of 2,3,6,7,10,11-hexamethoxytriphenylene (1) in a form of yellowish solid is prepared. The yield of which is 67%.

After then, the 2,3,6,7,10,11-hexamethoxytriphenylene (7.32 g, 19 mmol) is dispersed in a mixture having a concentration of 47% and consisting of HBr and acetic acid. The oxygen is then removed from the mixture solution by transmiting nitrogen atmosphere therein and subsequently subjecting it to heating for 24 hours under recirculation of nitrogen atmosphere. The obtained dark black solid liquid is subjected into annealing and thereby a gray white solid is collected. after that, the gray white solid is further purified and re-crystalized by utilizing H₂O/HoAc (3:2, 500 ml) and then a white solid of 2,3,6,7,10,11-hexahydroxytriphenylene (2) in a needle form is prepared. The yield of which is 73%.

Preparing a solution of dichloromethane (50 ml) consisting of 4-(undecenyloxy)-1-benzoic acid (15 mmol) several drops of N,N-dimethylforamide and excess thionyl chloride and subsequently stirring it for 2 hours at a room temperature under nitrogen atmosphere to remove solvent and the thionyl chloride in amount of overdose. Then, the dichloromethane solution of obtained 2,3,6,7,10,11-hexahydroxytriphenylene (2) (25 mmol) and triethylamne are added into it in sequence under a condition of room temperature, nitrogen atmosphere and in a ice bath. After stirring it for 12 hours, removing the solvent, dissolving the obtained solid solution into acetyl acetate, washing with 5% of K₂CO₃ aqueous solution, after then subjecting it into purification of using column chromatography (extracting liquid EA/Hexane 5:1), and thereby 4.0 g of a light yellow condensed substance of 2,3,6,10,11-hexakis [4-(undecenyloxy)-1-benzoate]triphenylenes (3) is prepared. The yield of which is 85%.

Then, 10.0 g (35 mmol) of 2,3,6,10,11-hexakis [4-(undecenyloxy)-1-benzoate]triphenylenes (3) and 6.04 g (35 mmol) of meta-chloroperoxybenzoic acid (MCPBA) are dissolved into 500 ml of CH₂Cl₂ and then stirring it for 12 hours under a system without any light and nitrogen atmosphere at a room temperature to remove solvent. The obtained solid is dissolved in 250 ml of acetyl acetate, extracted it by K2CO3 aqueous solution and then washing the organic layer with saturated salt water. Subsequently, the obtained condensed substance after completion of removing solvent is further purified by column chromatography (extracting liquid: acetyl acetate/n-hexane=5:1) and then 9.6 g of a light yellow condensed substance of 2,3,6,10,11-hexakis [4-(ω-epoxynonayloxy)-1-benzoate]triphenylenes (M1). The yield of which is 92%.

2. The Synthesis of a Rod-Like Liquid Crystal Molecule of 4 [2-(4-hexylphenyl)-1-ethynyl]-2-methyl-1[2-(4-ethylphenyl)-1-ethynyl]benzene (PTP(Me)TP62):

The one of preferred embodiments of a rod-like liquid crystal molecule used in the invention is 4 [2-(4-hexylphenyl)-1-ethynyl]-2-methyl-1[2-(4-ethyl-phenyl)-1-ethynyl]benzene (PTP(Me)TP62). The synthesis of a rod-like liquid crystal molecule of PTP(Me)TP62 can be achieved by utilization the process such as represented by the scheme 2 of synthesis described as following.

Firstly, the m-toludiene (9.3 mol), sodium hydrogen carbonate (14.3 mol) and water (8 ml) added into a flask bottle and cooling it. After then, adding iodine (7.9 mol) therein by 2-3 times and stirring it for 1 hour by keeping at same temperature. The water is added therein and the extracted it with ether. The organic layer is washed with saturated sodium thiosulfate

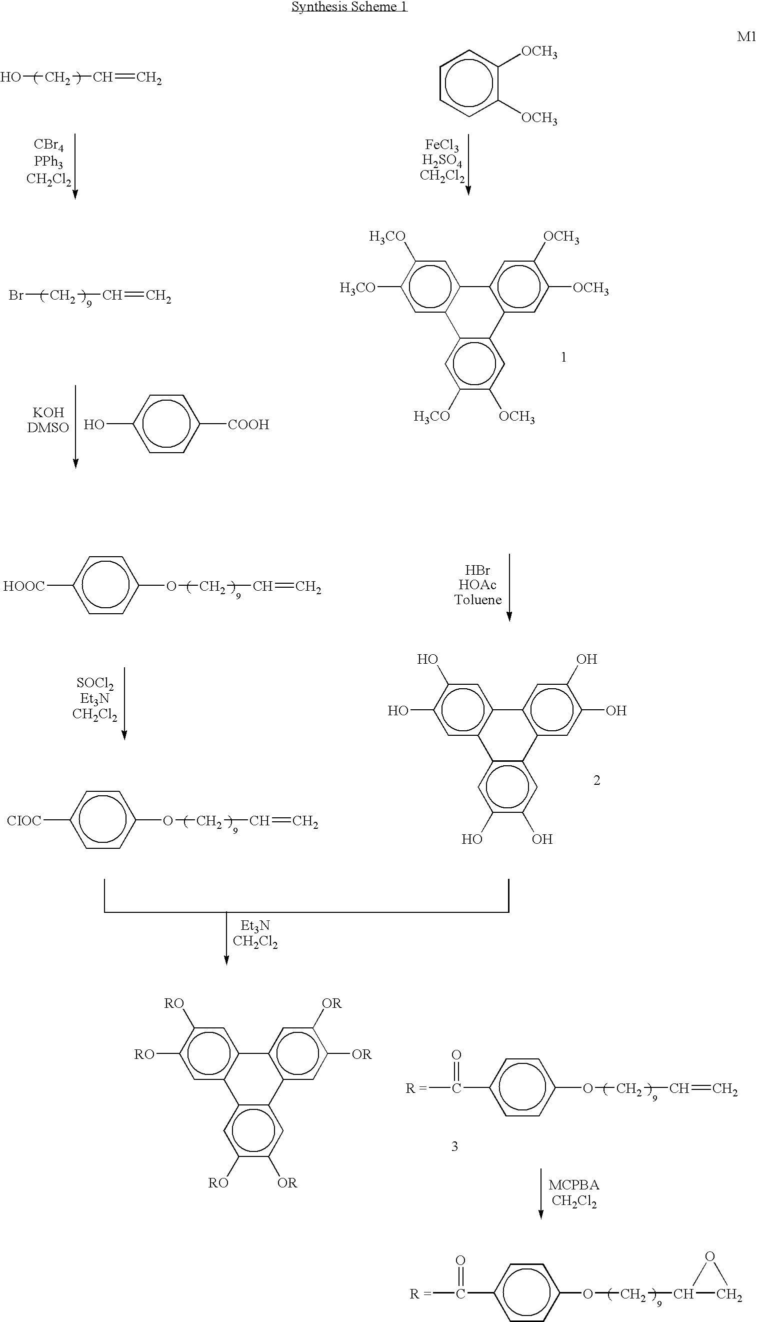

solution, water and saturated salt water and then drying it with anhydro-magnesium sulfate, condensing it, separating it by using silca gel column chromatography (extracting liquid:acetyl acetate:n-hexane=1:4) and then a clean oil liquid of 4-ioidinium-3-methylanilino compound (4) with a light purple color is prepared. The yield of which is 75.2%.

Subsequently, the obtained 4-ioidinium-3-methylanilino compound (4) (8.38 g, 36 mmol) and 1-(1-ethylene)-4-ethylbenzene compound (45 mmol) dissolved in 100 ml of triethyl amine and disposed it in a flask bottle. Under a circumstance of nitrogen atmosphere, triphenyl phosphine (2.7 mmol), bis(triphenyl phosphono) palladium (II) chloride (0.36 mmol) and copper iodide (1.3 mmol) are added therein respectively and then heating it for one day under recirculation. After cooling, removing the excess solvent, diluting it with ether and then washing it with saturated sodium thiosulfate solution, water and saturated salt water and then drying it with anhydro-magnesium sulfate, condensing it, separating it by using silca gel column chromatography (extracting liquid: acetyl acetate:n-hexane=1:4) and then a brown solid of 4 [2-(4-ethylphenyl)-1-ethynylene]-3-methyl-aniline (5) is prepared. The yield of which is 86%.

Then, the obtained 4 [2-(4-ethylphenyl)-1-ethynylene]-3-methyl-aniline (5) (29 mmol) is dissolved in 15 ml of THF. After cooling, pouring it into ice nitrous acid solution consisting of condensed sulfuric acid (16 ml) and sodium nitrous acid (17.5 ml) to form a mixture. The obtained mixture is then added into ice aqueous solution (6M, 50 ml) made of potassium iodine and stirring it for 2-3 hours at same temperature. Subsequently, washing it with saturated sodium thiosulfate solution, extracting it with n-hexane, and then washing the organic layer with water and saturated salt water, drying it with anhydro-magnesium sulfate, condensing it, separating it by using silca gel column chromatography (extracting liquid: n-hexane) and then a white solid crystal of 2-[2-(4-ethylphenyl)-1-ethynylene]-5-iodinium toulene (6) is prepared. The yield of which is 27%.

Subsequently, the solution consisting of 2-[2-(4-ethylphenyl)-1-ethynylene]-5-iodinium toulene (6) (8.3 mmol), 1-(1-ethylene)-4-ethyl benzene compound (15 mmol), bis(triphenyl phosphine) palladium (II) chloride (60 mg, 0.083 mmol) and copper iodide (60 mg, 0.31 mmol) is heated for one day under recirculation. After cooling, removing the excess solvent, diluting it with n-hexane and then washing it with saturated ammonium chloride solution, water and saturated salt water and then drying it with anhydro-magnesium sulfate, condensing it, separating it by using silca gel column chromatography (extracting liquid: n-hexane) and then a white solid crystal of 4 [2-(4-hexylphenyl)-1-ethynyl]-2-methyl-1 [2-(4-ethylphenyl)-1-ethynyl]benzene (PTP(Me)TP62) is prepared. The yield of which is 73.8%.

3. The Synthesis of a Rod-Like Liquid Crystal Molecule of p-[4-(ω-epoxypropyloxy)]phenyl)-trans-4-n-pentylcyclohexanoate (EBC55):

Another preferred embodiment of a rod-like liquid crystal molecule used in the invention is p-[4-(ω-epoxypropyloxy)]phenyl)-trans-4-n-pentylcyclohexanoate (EBC55). The synthesis of a rod-like liquid crystal molecule of EBC55 can be achieved by utilization the process such as represented by the scheme 3 of synthesis described as following. Firstly, hydroquinone (0.025 mol), potassium hydrogen oxide (1.82 g, 0.032 mol) and potassium iodine (0.1 g) are dissolved in 120 ml of ethanol (90%) and then heating it for one hour under recirculation. Subsequently, dropwise added 5-bromo-1-pentene (0.05 mol) and then recirculating it for 20 hours. Filtrating, cooling and condensing it and then subjecting it into re-crystalization with a mixture solution of methanol/water. A 85% of white solid crystal product of p-(4-pentylene)-1-oxy)phenol (7) is obtained in a yield of 75%. The melting point of which is 49.73° C.

The trans-4-pentyl cyclohexane-carboxylic acid (4.34 mmol) is dissolved into dichloromethane (7 ml). At the time of 30 minutes after the reaction with thionyl chloride (3 ml), carrying a reaction by injecting 2 drops of dimethylformamide (DMF) out for 2 hours, removing dichloromethane and unreacted thionyl chloride from system by vacuum and thereby a yellowish product of acid chloride is prepared.

Subsequently, at the temperature of 0° C., slowly adding a dichloromethane (10 ml) solution of acid chloride into dichloromethane (100 ml) consisting of the p-(4-pentylene)-1-oxy)phenol (7) (4.77 mmol) and dimethyl-aminopyridine (DMAP, 0.7 g) dissolved therein, directly distilling dichloromethane out from hot water bath by using a simple distillation

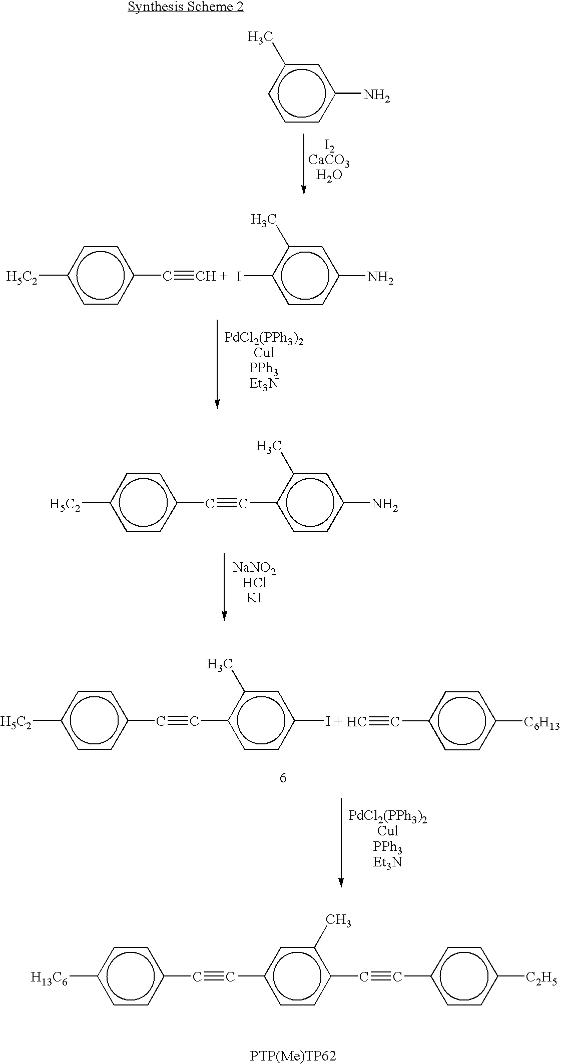

apparatus after keeping in reaction at room temperature for 2 hours and thereby a light yellowish solid is prepared. Subsequently, separating it by using silca gel column chromatography (extracting liquid: acetyl acetate: n-hexane=1:4) and then a white solid of p-(4-pentylene)-1-oxy)pentyl trans-4-pentyl cyclohexane-carboxylic acid (8) is prepared. The yield of which is 71%.

After then, the p-(4-pentylene)-1-oxy)pentyl trans-4-pentyl cyclohexane-carboxylic acid (8) (5 mmol) and meta-chloroperoxybenzoic acid (MCPBA, 5.5 mmol) is dissolved in CH₂Cl₂. Subsequently, stirring it for 12 hours at a room temperature under nitrogen atmosphere to remove solvent. Then, the obtained solid is dissolved into it in acetyl acetate and washing the organic layer with K₂CO₃ aqueous solution. After then, subjecting it into purification of using column chromatography (extracting liquid EA/Hexane=7:1) and further purifying it to obtain a white condensed substance of stirring it for 2 hours at a room temperature under nitrogen atmosphere to remove solvent and the thionyl chloride in amount of overdose.

Then, the dichloromethane solution of obtained 2,3,6,7,10,11-hexahydroxytriphenylene (2) (25 mmol) and triethylamne are added into it in sequence under a condition of room temperature, nitrogen atmosphere and in a ice bath. After stirring it for 12 hours, removing the solvent, dissolving the obtained solid solution into acetyl acetate, washing with 5% of K₂CO₃ aqueous solution, after then subjecting it into purification of using column chromatography (extracting liquid EA/Hexane 5:1), and thereby 4.0 g of a light yellow condensed substance of p-[4-(ω-epoxypropyloxy)]phenyl)-trans-4-n-pentylcyclohexanoate (EBC55) is prepared. The yield of which is 90% ∘

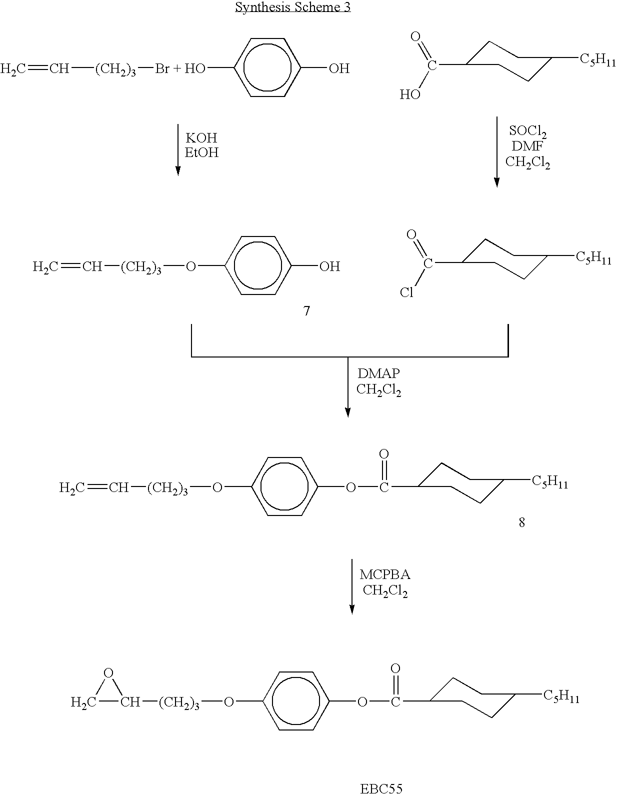

### EXAMPLE 1

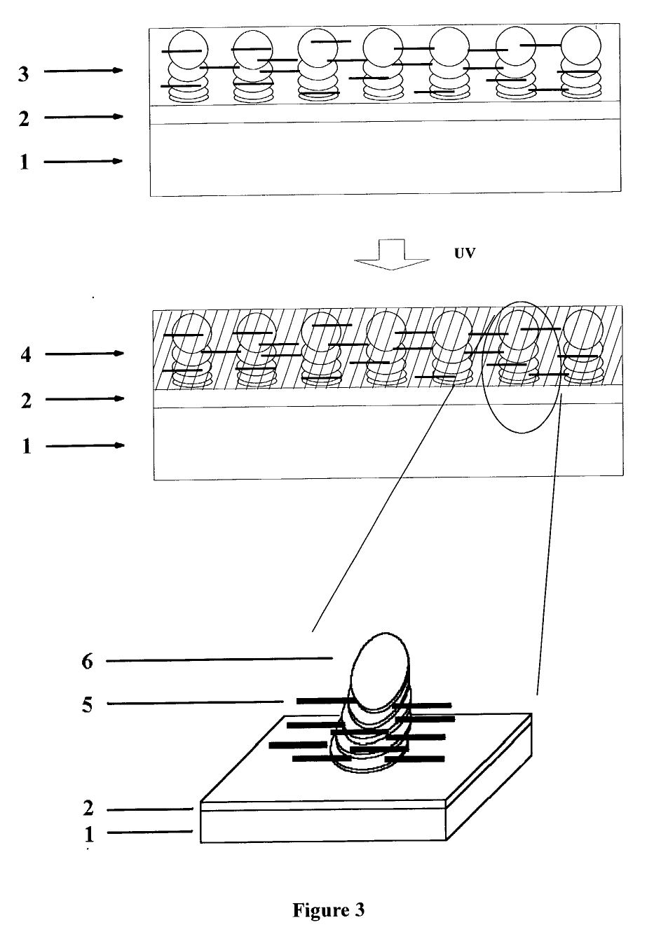

The alignment layer 2 was prepared by coating made of polyamide onto a glass substrate 1 according to FIG. 3. Firstly, a film formed from polyamide is laminated on a glass substrate 1 by utilizing spin-on coating method through spin-on coating machine VE-300. Subsequently, the resulted film is changed into a polyimide film by using a dehydrating process in high temperature. Then, the polyimide film is treated by orientation treatment of rubbing with lint and thereby an alignment layer 2 having capability of aligning crystal is prepared.

Further, the 2,3,6,10,11-hexakis [4-(ω-epoxynonayloxy)-1-benzoate]triphenylenes (M1) and 4 [2-(4-hexylphenyl)-1-ethynyl]-2-methyl-1-[2-(4-ethyl phenyl)-1-ethynyl]benzene (PTP(Me)TP62) obtained from aforesaid synthesis examples were dissolved in 1 ml of methyl ethyl ether. After filtration, a mixture solution consisting of a discotic liquid crystal (M1) and a rod-like liquid crystal (PTP(Me)TP62) was prepared. The mixture solution consisting of M1 and PTP(Me)TP62 was coated onto an alignment layer 2 by two stags of 1000 rpm/sec for 5 seconds (the first stage) and 2000 rpm/sec for 10 seconds (the second stage). Subsequently, the obtained glass substrate comprising coating of a mixture solution consisting of a discotic liquid crystal (M1) and a rod-like liquid crystal (PTP(Me)TP62) was baked at 125° C. for 3 minutes. After drying, the sample was subjected to observation carrying out by polarized microscope to make sure that the coating of a mixture solution already formed a thin film with unidirectional arrangement.

Then, the sample was subjected to polymerization carrying out by exposing under UV light system of using high pressure Hg lamp as UV light source with 10 mW/cm² of luminance from a Xe bulb (1000 W) through a filtrating plate (Oriel model 59640) for 3 minutes and thereby an optical retardation film with polymerized crosslinked structure consisting of a discotic liquid crystal (M1) and a rod-like liquid crystal (PTP(Me)TP62) was prepared.

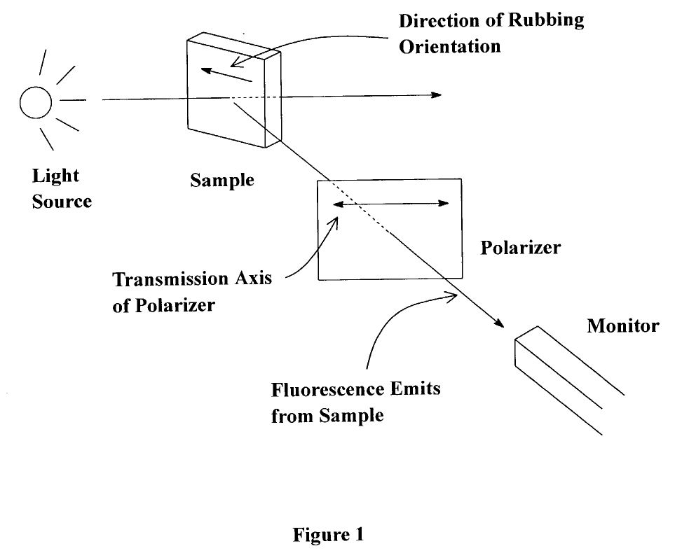

With regard to the known direction of rubbing orientation within the sample as shown on FIG. 1, in case that the lower content of rod-like liquid crystal presented in the obtained optical retardation film was arranged depending on the discotic liquid crystal after orientation and thereby the irradiation produced from rod-like liquid crystal PTP(Me)TP62 in a fluorescence spectrum meter must have orientation. More, in case of rotating the sample, the relationship among the direction of rubbing orientation, the direction transmitting through the polarizer and the strength of fluorescence through the polarizer could be measured because that only the light paralleling light-through axial of polarizer can transmit through when the irradiation transmits through a fix polarizer in front of a monitor. Namely, the alignment of liquid crystal can be determined and simultaneously whether the arrangement of a rod-like liquid crystal is parallels or perpendicular with the direction of rubbing orientation also can be determined.

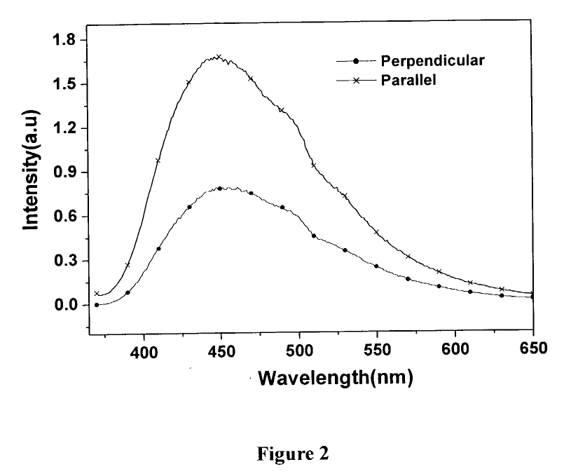

According to the procedure shown on FIG. 1, the fluorescence spectrum of the obtained glass substrate comprising aforesaid optical retardation film was measured by using fluorescence spectrum meter (Shimadzu manufactured, model 5301 PC). The results of measurement are as shown on FIG. 2. It has been observed that the normality constant of PTP(Me)TP62 in the film is 0.42, which is determined from the calculation of ratio between the highest strength of parallel light and the highest strength of perpendicular light. It means that the alignment of rod-like liquid crystal actually depends on the alignment of discotic liquid crystal in the obtained optical retardation film and the long axial of PTP(Me)TP62 molecule parallels the direction of rubbing orientation. Namely, the alignment of the portion of rod-like liquid crystal, in the sample comprising a coating film consisting of discotic and rod-like liquid crystal manufactured by the process according to the invention, parallels the direction of rubbing orientation. Therefore, the film obtained by the process according to the invention is a unidirectional film, which has property of unidirection the same as A-plate.

Further, in the sample comprising a coating film consisting of discotic and rod-like liquid crystal manufactured by the process according to the invention, the discotic liquid crystal has no property of fluorescence and merely the rod-like liquid crystal PTP(Me)TP62 can emit fluorescence. Thus, it is firmly sure that the alignment of the rod-like liquid crystal PTP(Me)TP62 consists with the requirement of having a form the same as A-plate film. So, the optical retardation film consisting of discotic and rod-like liquid crystal manufactured by the process according to the invention has a hybrid structure the same as Fuji wide viewing angle film (WVF), as well as has property of unidirection the same as A-plate film. Namely, the optical retardation film manufactured by the process according to the invention has both positive and negative type of optical properties.

### EXAMPLE 2

The procedures of EXAMPLE 1 were repeated, except that the mixture solution of liquid crystal formation consisting of EXAMPLE 1 consisting of M1 and PTP(Me)TP62 is changed into a liquid crystal formation consisting of 0.5 g of discotic liquid crystal (M1), 0.0007 g of diphenyliodonium hexafluoroarsenate used as photoinitiator and 0.1 g of p-[4-(ω-epoxy propyloxy)]phenyl)-trans-4-n-pentylcyclohexanoate (EBC55) dissolved in 1 ml of methyl ethyl ether. After filtration, a mixture solution consisting of a discotic liquid crystal (M1), photoinitiator and a rod-like liquid crystal (EBC55) was prepared. According to the same coating procedures of EXAMPLE 1, the mixture solution consisting of M1, photoinitiator and EBC55 was coated onto an alignment layer 2 of glass substrate 1 under the same operating conditions of EXAMPLE 1.

Subsequently, the obtained glass substrate comprising coating of a mixture solution consisting of M1, photoinitiator and EBC55 was baked at 125° C. for 3 minutes and 70° C. for 2 minutes. After drying, the sample was subjected to observation carried out by polarized microscope to make sure that the coating of a mixture solution already formed a thin film with unidirectional arrangement, which has a structure as same as the film shown on FIG. 3. After then, according to the same coating procedures of EXAMPLE 1, the sample was subjected to exposing under luminance of 10 mW/cm² of UV light for 3 minutes and thereby an optical retardation film 4 with polymerized crosslinked structure shown on FIG. 3 was prepared. The alignment of liquid crystal microstructure presented in the optical retardation film 4 are shown as 5 and 6 of FIG. 3.

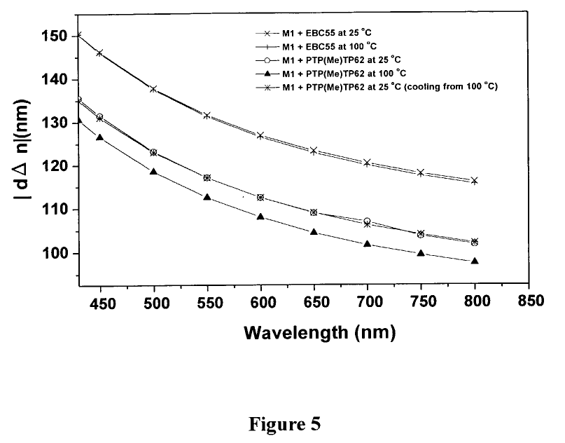

Further, the relationship between measured angle and Re/Re₄₀ at various angles of the optical retardation film 4 manufactured from the mixture solution consisting of M1, photoinitiator and EBC55 was measured by multiple channel optical instrument of PCPD-2000 (Otsuka manufactured) birefringence meter. Firstly, the optical retardation film 4 consisting of M1, photoinitiator and EBC55 was measured at 25° C. for retardation at various wave length by using the PCPD-2000 birefringence meter. Subsequently, the optical retardation film 4 consisting of M1, photoinitiator and EBC55 was baked at 100° C. for 30 minutes and then the optical retardation film 4 was measured for retardation at various wave length by using the same birefringence meter mentioned above. Both results of the optical retardation film 4 measured at 25 and 110° C. were shown on FIG. 5. It has been observed that the optical retardation film 4 consisting of M1, photoinitiator and EBC55 has excellent stability of heat and thus the retardation of which is not changed with temperature.

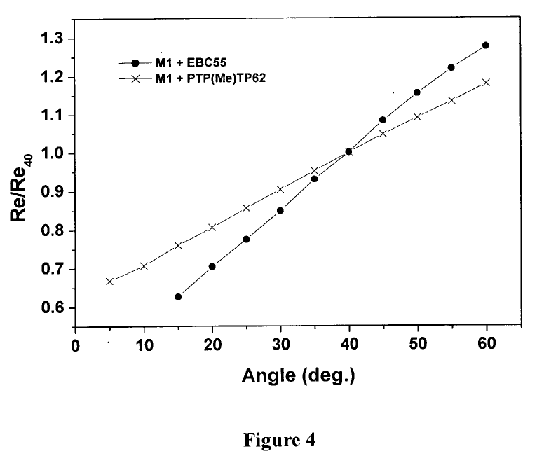

Furthermore, according to the data shown on FIG. 4 and FIG. 5, It has been observed that the optical retardation film 4 consisting of M1, photoinitiator and EBC55 has same optical properties as same as EXAMPLE 1. That is, the optical retardation film 4 consisting of M1, photoinitiator and EBC55 manufactured by the process according to the invention has a hybrid structure, same as Fuji wide viewing angle film (WVF), as well as unidirection property as A-plate film. Namely, the optical retardation film manufactured by the process according to the invention has both positive and negative type of optical properties.

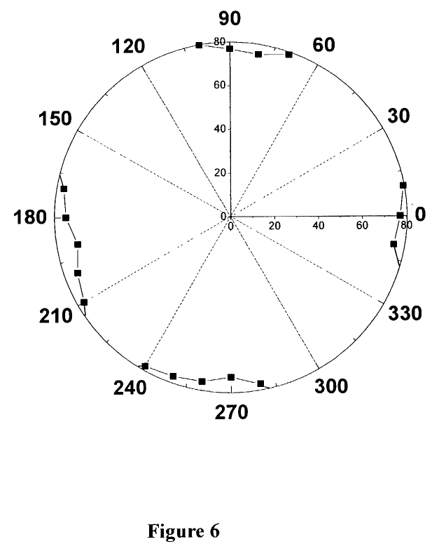

Additionally, according to the measured data of viewing angles shown on FIG. 6, It has been observed that the optical retardation film 4 consisting of M1, photoinitiator and EBC55 expresses widen viewing angle up to a range of closely 80° at a contrast of 100 since it has both positive and negative type of optical properties.

### EXAMPLE 3

The substrate and alignment layer to be used is the same material of Example 1. The procedures of EXAMPLE 1 were repeated, except that the mixture solution of liquid crystal formation consisting of EXAMPLE 1 consisting of M1 and PTP(Me)TP62 is changed into a liquid crystal formation consisting of 0.5 g of discotic liquid crystal (M1), 0.0007 g of diphenyliodonium hexafluoroarsenate used as photoinitiator and 0.1 g of 4 [2-(4-hexylphenyl)-1-ethynyl]-2-methyl-1[2-(4-ethylphenyl)-1-ethynyl]benzene (PTP(Me)TP62) dissolved in 1 ml of methyl ethyl ether. After filtration, a mixture solution consisting of a discotic liquid crystal (M1), photoinitiator and a rod-like liquid crystal (PTP(Me)TP62) was prepared. According to the same coating procedures of EXAMPLE 1, the mixture solution consisting of M1, photoinitiator and PTP(Me)TP62 was coated onto an alignment layer 2 of glass substrate 1 under the same operating conditions of EXAMPLE 1.

Subsequently, the obtained glass substrate comprising coating of a mixture solution consisting of M1, photoinitiator and PTP(Me)TP62 was baked at 125° C. for 3 minutes. After drying, the sample was subjected to observation carrying out by polarized microscope to make sure that the coating of a mixture solution already formed a thin film with unidirectional arrangement, which has a structure as same as the film shown on FIG. 3. After then, according to the same coating procedures of EXAMPLE 1, the sample was subjected to exposing under luminance of 10 mW/cm² of UV light for 3 minutes and thereby an optical retardation film 4 with polymerized crosslinked structure shown on FIG. 3 was prepared.

Further, the relationship between measured angle and Re/Re₄₀ at various angles of the optical retardation film 4 manufactured from the mixture solution consisting of M1, photoinitiator and PTP(Me)TP62 was measured by the same birefringence meter used in EXAMPLE 2. According to the same procedures of EXAMPLE 2 for measurement of retardation, the optical retardation film 4 consisting of M1, photoinitator and PTP(Me)TP62 was measured at both 25° C. and after baking at 100° C. for 30 minutes. Both results of the optical retardation film 4 measured at 25 and 100° C. were shown on FIG. 5. It has been observed that the retardation of optical retardation film 4 consisting of M1, photoinitiator and PTP(Me)TP62 is changed depending on temperature. The retardation of optical retardation film 4 consisting of M1, photoinitiator and PTP(Me)TP62 measured at all various wave length is low down while temperature is up. However, the retardation of optical retardation film 4 consisting of M1, photoinitiator and PTP(Me)TP62 would comeback to original value while the temperature of which is down to 25° C. again.

### EFFECT OF THE INVENTION

Generally, the conventional liquid crystal cell usually is TN liquid crystal cell, the typical viewing angle of which is quite narrow beyond requirement according to the report made by T. Sergan, W. Liu, J. Kelly, H. Yoshimi, (“J. Appl. Phys.”, vol. 37, 1998, pp. 889) Thus, the TN liquid crystal cell generally has an serious problem of viewing angle. For example, the highest contrast in viewing angle of TN liquid crystal cell without adding any compensating film is merely 70 and the range of which is quite narrow. In addition, even though the highest contrast in viewing angle of TN liquid crystal cell with negative optical retardation film can up to 10, however the viewing angle of which is between a range of 65° in left-right and 60° in up-down only.

On the other hand, according to the data shown on FIG. 6, it has been observed that the viewing angle of optical retardation film of the invention can up to 80°, which implies the optical retardation film having both positive and negative type of optical properties of the invention has excellent retardation for optical compensation. Therefore, the optical retardation film consisting of a discotic liquid crystal and a rod-like liquid crystal manufactured by the process according to the invention has excellent and stable optical properties that the retardation of optical retardation film dose not change with the temperature and has capability of broadly increasing viewing angle. Thus, optical retardation film manufactured by the process according to the invention can be widely used in optical industry.

Additionally, optical retardation film of the invention also suitable to be widely used in LCD industry, particularly the LCD comprising an optical retardation film in order to reduce the defect of viewing angle. The LCD can achieve the objects of maximum area and highest performance of display panel provided that the LCD comprises an optical retardation film of the invention. Thus, it is firmly sure that the optical retardation film manufactured by the process according to the invention can be widely used in industry and has industrial applicability.

Symbol of Drawing

1 Glass substrate

2 Alignment layer

3, 4, 5, 6 Positive/negative type optical retardation film

Although specific embodiments have been illustrated and described it will be obvious to those skilled in the art that various modifications may be made without departing from the spirit which is intend to be limited solely by the appended claims.

1. A process for preparing optical retardation film, which is characterized in that the process comprises preparing an alignment layer consisting of a crosslinkable structure of polymer material onto the clean substrate consisting of glass or plastics, coating a liquid crystal formulation of a mixture of blending a discotic liquid crystal molecule with a rod-like liquid crystal molecule onto the alignment layer, forming a coating layer with function of optical compensation after curing it through exposing under a UV light, and thereby obtaining a positive-negative blended optical retardation film.

2. The process for preparing optical retardation film as claimed in claim 1, in which the process comprises further separating the coating layer with property of optical retardation.

3. The process for preparing optical retardation film as claimed in claim 1 or 2, in which the transparent substrate is glass.

4. The process for preparing optical retardation film as claimed in claim 1 or 2, in which the transparent substrate is a soft plastic comprising any one selected from a group consisting of polycarbonate, polyether sulfone, polymethyl methacrylate and polytriacetyl cellulose.

5. The process for preparing optical retardation film as claimed in claim 1 or 2, in which the alignment layer comprises any one selected from the group consisting of polyimide (PI), polyvinyl alcohol (PVA) and a discotic containing polymer.

6. The process for preparing optical retardation film as claimed in claim 1 or 2, in which the alignment layer is achieved by a rubbing orientation or an optical orientation.

7. The process for preparing optical retardation film as claimed in claim 1 or 2, in which the disclostic liquid crystal molecule having a photo-sensitive functional group for photo polymerization comprising any one or more monomer selected from a group consisting of a discotic liquid crystal acrylate, discotic liquid crystal methyl acrylate, a discotic liquid crystal ethylene oxide, a discotic liquid crystal coumarin, a discotic liquid crystal cinnamate, and a discotic liquid crystal cinnamic alcohol.

8. The process for preparing optical retardation film as claimed in claim 1 or 2, in which the discotic liquid crystal molecule is 2,3,6,10,11-hexakis [4-(ω-epoxynonyloxy)-1-benzoate]triphenylenes.

9. The process for preparing optical retardation film as claimed in claim 1 or 2, in which the liquid crystal formulation further comprises a photoinitiator.

10. The process for preparing optical retardation film as claimed in claim 9, in which the photoinitiator is any one or more radical photoinitiators selected from the group consisting of benzoin benzil and benzophenone.

11. The process for preparing optical retardation film as claimed in claim 9, in which the photoinitiator is any one or more anionic photoinitiators selected from the group consisting of diphenyliodonium-hexafluoroarsenate, diaryl-iodonium-hexafluoroantimonate and triarylsulfonium-hexafluoroantimonate.

12. The process for preparing optical retardation film as claimed in claim 9, in which the photoinitiator is diphenyliodonium-hexafluoroarsenate.

13. The process for preparing optical retardation film as claimed in claim 1 or 2, in which the rod-like liquid crystal molecule having a photo-sensitive functional group for photo polymerization comprising any one or more monomers selected from a group consisting of a liquid crystal acrylate, a liquid crystal methyl acrylate, a liquid crystal ethylene oxide, a liquid crystal coumarin, a liquid crystal bisacrylate, a liquid crystal bismethyl acrylate, a liquid crystal bisethylene oxide, a liquid crystal biscoumarin, a liquid crystal cinnamate and a liquid crystal cinnamic alcohol.

14. The process for preparing optical retardation film as claimed in claim 1 or 2, in which the rod-like liquid crystal molecule is 4 [2-(4-hexylphenyl)-1-ethynyl]-2-methyl-1 [2-(4-ethylphenyl)-1-ethynyl]benzene.

15. The process for preparing optical retardation film as claimed in claim 1 or 2, in which the rod-like liquid crystal molecule is p-[4-(ω-epoxypropyloxy)]phenyl)-trans-4-n-pentylcyclohexanoate.

16. The process for preparing optical retardation film as claimed in claim 1 or 2, in which the liquid crystal formulation of a mixture of blending a discotic liquid crystal molecule with a rod-like liquid crystal molecule uniformly coated onto the alignment layer is achieved by a process of continuous or batch coating.

17. The process for preparing optical retardation film as claimed in claim 1 or 2, in which the temperature for photo-polymerization is in the range of 15° C. to 180° C.

18. The process for preparing optical retardation film as claimed in claim 1 or 2, in which the resulted optical retardation film is suit for using in a liquid crystal element or a liquid crystal display.

19. The process for preparing optical retardation film as claimed in claim 1 or 2, which is used for the production of a liquid crystal element or a liquid crystal display comprising an optical retardation film.

20-32. (canceled).
